(19) United States
(12) Patent Application Publication
(10) Pub. No.: US 2003/0222990 A1
(43) Pub. Date: Dec. 4, 2003

(54) Video camera for transmitting video, audio and control signals to a remote recording device

(76) Inventors: John Driska, Princeton, NJ (US); Isaac Ashkenazi, Brooklyn, NY (US)

Correspondence Address: Neil M. Zipkin, AMSTER, ROTHSTEIN & EBENSTEIN, 21st Floor, 90 Park Avenue, New York, NY, 10016, US

(21) Appl. No.: 10/157,534

(22) Filed: May 29, 2002

(51) Int. Cl. H04N 5/232

(52) U.S. Cl. 348/211.2

(57) ABSTRACT

A wireless video camera system for transmitting audio and video information generated by a video camera over an RF-link to a remotely located recording device via a base station/converter box. The video camera also includes a number of user selectable keys corresponding to recording device control functions which are also transmitted over the RF-link and which are used to control the operations of the recording device.

### BACKGROUND OF THE INVENTION

This invention generally relates to the field of hand-held video cameras, and more particularly to hand-held video cameras and systems which transmit video and audio information as well as control signals over a radio frequency (RF) link to a remotely located converter box which, in turn, provides corresponding video, audio, and control signals to a recording device such as a video cassette recorder (VCR).

Video cameras which transmit video and audio information over a radio frequency and video camcorders (i.e., video cameras with internal recording capability) are well known in the art. These video cameras and camcorders typically include a lens which focuses light reflected from an object or scene being photographed onto a small semiconductor image sensor such as charge coupled device (CCD) or CMOS sensor. These image sensors comprise an array of thousands of tiny light-sensitive photosites. Each photosite measures the amount of light that hits a particular point, and translates this information into electrical image signals. In the case of video camcorders, these electronic image signals are subsequently processed and formatted in the video camera and recorded on a removable storage medium such as a magnetic tape. However, since video camcorders include recording components (e.g., a rotating head drum with recording heads, audio head, etc.) as well as mechanical components for advancing the tape, they are typically larger, heavier, and more expensive than a stand alone video camera.

Recently, video camcorders have become available which store video and audio information on a miniaturized recording media such as compact tapes or discs. While the use of compact recording media has enabled the size and weight of video camcorders to be reduced, the compact recording media for these video camcorders are typically not directly compatible with standard playback devices such as VCRs and either require an additional interfacing device to play back the video and audio information stored on the compact recording media or require the outputs of the video camcorder to be directly coupled to the playback device.

Alternatively, rather than store the video information on removable medium, the video information generated by a video camera can be viewed real time on a monitor remotely located from the video camera. Such systems are typically employed in security and surveillance systems. In such systems, video information generated by a video camera is transmitted over an RF link to a receiver at a remotely located monitor. For example, a product referred to as XCam2 includes a small wireless camera including a 2.4 GHz transmitter and a stand alone receiver having standard video outputs which can be connected to a television or VCR. Video information generated by the camera located, e.g., at the entrance of one's home, can be transmitted to the receiver located in the house and viewed on a monitor. Alternatively, the video outputs from the receiver can be connected to a VCR so that the video information generated by the remotely located camera can be recorded. However, in such a system, recording can only be initiated by a person at the location of the VCR, and cannot be initiated or controlled by a person at the remotely located camera.

Remote control devices are also well known in the art. Practically all commercial available audio or video products include remote control devices which can be used to turn the products on and off as well as control their mode of operation. These remote control devices typically transmit signals over an infrared (IR) link to an IR input port on the product, and therefore must be used in the line of sight of the product in order to work reliably. To overcome this shortcoming, prior art references disclose the use of RF remote control devices. For example, U.S. Pat. No. 4,916,532 describes a system having a video source such as a VCR which transmits video and audio information via an RF transmitter to a receiver at a remote location which converts the RF signals to baseband signals which are displayed on televison set. The system also includes an IR controller at the location of the television set which transmits control information to an IR detector. The IR control signals are subsequently converted into an electrical coded signal which is transmitted by a remote control transmitter which operates on one of the frequencies provided for the local transmission of coded information (e.g., those employed by garage door openers) to a remote control receiver at the location of the VCR. The remote control receiver outputs the received control signals to an IR repeater which, in turn, provides IR inputs to an IR detector of the VCR.

### SUMMARY OF INVENTION

Accordingly, it is the object of the present invention to provide a small, lightweight, and inexpensive video camera which can be used in conjunction with a standard recording device such as a VCR to record audio and video information generated by the video camera.

It is also the object of the present invention to provide a video camera which transmits audio, video, and control signals over an RF-link to a remotely located base system which converts the received audio, video, and control signals into VCR compatible formats.

### BRIEF DESCRIPTION OF DRAWINGS

FIGS. 1A-1C are diagrams of the video camera of the preferred embodiment of the invention.

FIG. 2A is schematic diagram of a video camera having a RF transmitter in accordance with the preferred embodiment of the invention.

FIG. 2B is a schematic diagram of a base station/converter box having an RF receiver in accordance with the preferred embodiment of the invention.

FIGS. 3A-3B are diagrams of the base station/converter box of the preferred embodiment of the invention.

### DETAILED DESCRIPTION OF THE INVENTION

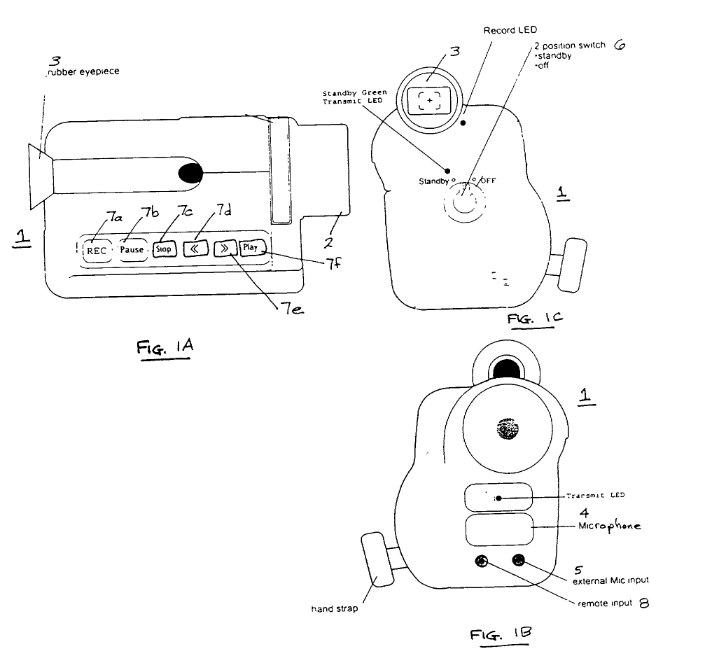

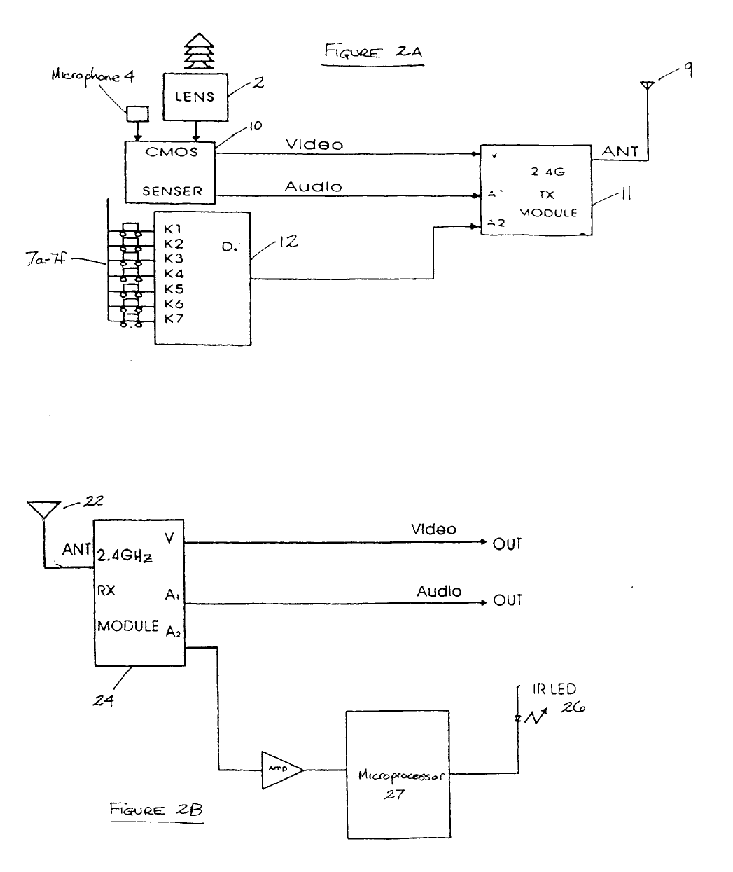

A detailed diagram of the video camera system of the preferred embodiment of the present invention is shown in FIGS. 1A-1C. As shown, video camera 1 includes a lens 2 through which light reflected from an object or scene being recorded is focused on an optical pick-up device 10 (FIG. 2A) such as a CCD or CMOS sensor which translates the detected image into a NTSC or PAL signal. Eyepiece 3 enables the user to accurately point the camera at the object being recorded. Video camera 1 also includes an integral microphone 4 for detecting and recording audio information as well as external jack 5 by which an external microphone (not shown) can be coupled to the video camera. The video camera also includes a mode selection switch 6 which enables the user to place the video camera into standby and off modes. Also included are a number of user selectable keys or buttons 7a-7f corresponding to standard VCR functions such as record, pause, stop, fast forward, rewind, and play. The video camera also includes an input jack 8 by which a remote control device (not shown) also having a plurality of user selectable keys or buttons corresponding to standard VCR functions can be coupled to the camera.

As shown in the schematic diagram FIG. 2A, video camera 1 also includes a 2.4 GHz RF transmitter 11 and associated antenna 9. RF transmitter 11 may be any one of a variety of commercially available integrated circuit (IC) transmitter chips or may be constructed from discrete components. The video information from the optical pick-up device 10 and audio information from microphone 4 are both provided as inputs to RF transmitter 11. Likewise, VCR control signals generated from user selectable keys 7a-7f are also provided via switch coding circuitry 12 as inputs to RF transmitter 11 which combines the audio, video, and control signals into a composite signal which is modulated at a 2.4 GHz carrier frequency and transmitted via antenna 9 to remotely located base station/converter box 20.

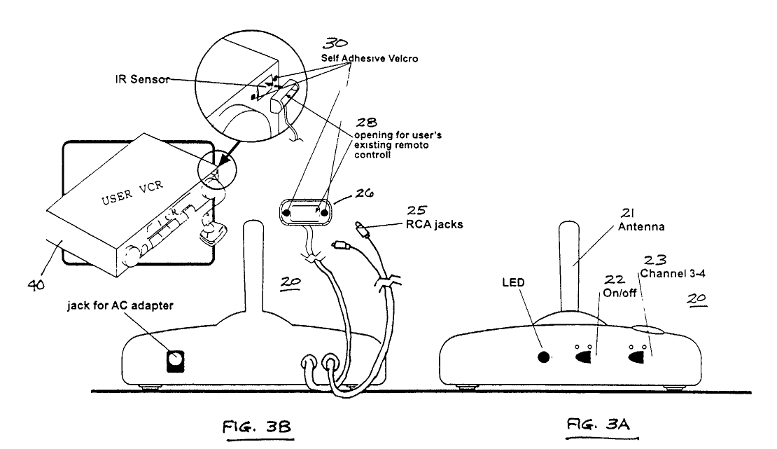

A diagram of the base station/converter box 20 is shown in FIGS. 3A-3B. As shown, base station/converter box 20 includes a rotatable antenna 21, on/off switch 22, and channel selection switch 23. As shown in the schematic diagram FIG. 2B, base station/converter box 20 also includes an RF receiver 24 coupled to antenna 21 for receiving, and demodulating the audio, video, and control signals transmitted by the video camera. Here again, RF receiver 24 may be any one of a variety of commercially available IC receiver chips or may be constructed from discrete components. As shown in FIG. 3B, the composite video and audio outputs from RF receiver 24 are provided to standard RCA jacks 25 which can be coupled to the standard video and audio inputs of a VCR. Base station/converter box 20 also includes a microprocessor or controller 27 for decoding received control signals and an IR light emitting diode (LED) 26 for generating IR signals corresponding to the control signals transmitted by the video camera compatible with the standard IR inputs included on commercially available VCRs. In one embodiment IR LED 26 is included in a housing 27 that can be physically coupled to the IR input of the VCR using, e.g., self adhesive velcro 30. Housing 27 includes an opening 28 allowing control signals from other remote control devices to also be received and processed by the VCR. Alternatively, IR LED 26 can be included in base station/converter box 20 with the control signals being transmitted to the VCR in the same manner as a commercially available remote control device.

The microprocessor 27 in base station/converter 20 may also include universal remote control programming and circuitry which is well known in the art and programming that can be activated by the user during initial system installation to interrogate and establish communications with the VCR.

In operation, a user of video camera 1 using the viewfinder/eyepiece 3 can point the lens 2 at the object or scene to be recorded. When the “record” key 7a is selected, the video camera transmits a corresponding control signal via the 2.4 GHz RF link to the remotely located base station/converter box 20. The base station/converter box 20 generates a corresponding “record” command signal at its IR output which is received by the VCR 40 at its IR input port. The VCR is placed into “record” mode and records the video and audio signals transmitted from the video camera over the 2.4 GHz RF link. If the user wants to interrupt recording, the “pause” key 7b can be selected and a “pause” command signal is transmitted over the RF link to the base station/converter box 20, converted into the appropriate IR signal, and output to the VCR placing the VCR in the “pause” mode. Recording can be resumed by re-selecting the “pause” button. When the user has finished recording, the “stop” button 7c is selected causing a “stop” command to be transmitted over the RF-link to the base station/converter box 20 which outputs a corresponding IR “stop” signal to the VCR 40 which responds accordingly.

Various additional modifications and improvements thereon will become readily apparent to those skilled in the art. For example, the RF-link between the video camera and base station/converter box need not utilize a carrier frequency of 2.4 GHz, but may be utilize a 900 MHz carrier frequency or other radio frequency. Additionally, the audio and video outputs from the base station/converter box need not be output as composite signals but may be formatted in any other well known video formats such as RGB and S-video, and be provided on any number of types of connectors such as a standard coaxial cable, etc. Further, the invention is not limited to use with VCRs, but may be used with any type of recording device, e.g., CD or DVD recorders. Accordingly, the spirit and scope of the present invention is to be construed broadly and limited only by the appended claims, and not by the foregoing specification.

What is claimed is:

1. A wireless video camera system comprising a video camera and base station, said video camera including (a) at least one user selectable key for generating a control signal for controlling a remotely located recording device, (b) an image pick-up device for generating video information, (c) a microphone for generating audio information, and (d) a radio frequency transmitter for transmitting said control signal, said video information, and said audio information, and said base station including (a) a radio frequency receiver for receiving and decoding the said control signal, said video information, and said audio information, (b) an infrared output coupled to said remotely located recording device for outputting said decoded control signals, (c) an audio output for outputting said decoded audio information, and (d) a video output for outputting said decoded video information.

2. The wireless video camera system of claim 1 wherein said radio frequency transmitter transmits said control signals, said audio information, and said video information over a 2.4 GHz link.

3. The wireless video camera system of claim 2 wherein said control signals, said audio information, and said video information are combined into a composite signal prior to transmission.

4. The wireless video camera system of claim 1 wherein said infrared output of said base station is physically attached to an infrared input port of the remotely located recording device.

5. The wireless video camera system of claim 1 wherein said base station includes universal remote circuitry means for establishing communications with said remotely located recording device.

6. The wireless video camera system of claim 1 wherein said remotely located recording device is a VCR.

7. The wireless video camera system of claim 1 wherein said remotely located recording device is a disc recorder.

8. A video transmission and recording system comprising:
(a) a video camera including (i) means for generating video information, (ii) means for generating control signals for a recording device, and (iii) transmitter means for transmitting said video information and said control signals over a radio frequency,
(b) a remotely located base station including (i) radio frequency receiver means for receiving and decoding said video information and said control signals, (ii) control signal output means for generating infrared recording device control signals corresponding to said received control signals, and (iii) output means for generating video signals, and
(c) recording means responsive to said recording device control signals for receiving and recording said video signals.

9. The video transmission and recording system of claim 8 wherein said video camera further includes means for generating and transmitting audio information and said base station further includes means for receiving and outputting said audio information which is recorded by said recording means.

10. The video transmission and recording system of claim 9 wherein said transmitter means combines said control signals, said video information, and said audio information into a composite signal prior to transmission, and said radio frequency receiver means decodes said composite signal into its component parts.

11. The video transmission and recording system of claim 9 wherein said transmitter means transmits said control signals, said audio information, and said video information over a 2.4 GHz link.

12. The video transmission and recording system of claim 8 wherein said control signal output means is physically attached to an infrared input port of the remotely located recording device.

13. The video transmission and recording system of claim 9 wherein said remotely located recording device is a VCR.

14. The video and audio transmission and recording system of claim 8 wherein said remotely located recording device is a recordable disc machine.

15. The video and audio transmission and recording system of claim 8 wherein said base station further includes universal remote circuitry means for automatically establishing a communication link with said recording device.

16. A method for transmitting, receiving and recording audio and video information utilizing a remotely located recording device, said method comprising the steps of:
(a) generating audio and video information and remote recording device control signals using a video camera at a first location,
(b) combining said audio and video information and said control signals into a composite signal,
(c) modulating said composite signal using a radio frequency carrier signal,
(d) transmitting said modulated composite signal to a second location,
(e) receiving said modulated composite signal at said second location,
(f) demodulating and decoding said composite signal into its audio, video, and control signal component parts,
(g) outputting said audio and video component parts to said recording device,
(h) generating an infrared control signal corresponding to said decoded control signal, and
(i) outputting said infrared control signal to said recording device.

17. The method of claim 16 wherein said recording device is a VCR.

18. The method of claim 16 wherein said remotely located recording device is a disc recorder.

19. The method of claim 16 wherein said radio frequency is 2.4 GHz.

20. The method of claim 16 wherein said radio frequency is 900 MHz.
